(19) United States
(12) Patent Application Publication
(10) Pub. No.: US 2026/0166498 A1
(43) Pub. Date: Jun. 18, 2026

(54) NANOBUBBLE GENERATOR

(71) Applicant: Nanobubble Agritech Limited, Oakura (NZ)

(72) Inventors: Leon POWER, Oakura (NZ); Daneel OVTCHARENKO, New Plymouth (NZ)

(21) Appl. No.: 19/113,419

(22) PCT Filed: Jan. 25, 2024
(86) PCT No.: PCT/NZ2024/050007

§ 371 Date: Mar. 19, 2025

(30) Foreign Application Priority Data
Jan. 27, 2023 (NZ) 795815

(51) Int. Cl. B01F 25/433; B01F 23/23; B01F 23/232; B01F 25/53; B82Y 30/00

(52) U.S. Cl. CPC B01F 25/433; B01F 23/23; B01F 23/232; B01F 25/53; B82Y 30/00; B01F 2215/0431

(57) ABSTRACT

A nanobubble generator suitable for high water flows, with low energy input, generating liquid flow containing a high volume of gas in the form of nanobubbles. The nanobubble generator includes a plurality of mixing tubes between an inlet manifold and an outlet manifold having internal helical guides configured to condition the two-phase fluid flow to produce a number of certain effects which in combination facilitate nanobubble generation.

This provides a nanobubble generator that at high water flows has high gas to liquid transfer efficiency and low head loss, is simple, inexpensive and easy to maintain.

### FIELD

This invention relates to a nanobubble generator.

### BACKGROUND

Nanobubbles are nano scale bubbles in a liquid, commonly used to refer to bubbles of a size up to 200 nm, but sometimes also including bubbles up to 999 nm. Nanobubbles are an effective mechanism for mass transfer of gas to liquid to obtain high dissolved gas concentrations up to six times the concentration of dissolved gas that water can hold under normal circumstances. Furthermore, nanobubbles have a strong bubble surface charge to repel each other, consequently reducing coalescence and staying in suspension for weeks or months.

Nanobubbles may be employed in horticulture, agriculture (including to reduce methanogens in animal rumens), aquaculture, wastewater, anaerobic digestion, cleaning, mining, oil and gas, drinking water (for human/agriculture/animals), industrial process (including industrial oxidation processes) and for improving water quality of lakes and ponds.

Nanobubbles in water have a mild oxidative effect that provides a long lasting chemical free treatment against a wide range of pathogens that negatively impact both plant and animal health. Nanobubble oxidation can be used to:
Destroy or inactivate pathogens like bacteria and viruses.
Prevent and mitigate algae blooms.
Prevent and eliminate compounds that cause off-flavours and foul odours.
Precipitate metals and degrade water contaminants.
Remove growth or build up algae in pipes/lines.

In horticultural applications nanobubbles can improve plant growth rate and yield. This is due to the provision of high levels of oxygen to root zone, delivered by water, which:
Promotes beneficial conditions for aerobic microbes, so that they can outcompete pathogens that thrive in anaerobic conditions, resulting in a better growing environment.
Provides more oxygen to the root zone to help increase soil microbial population and improve plant soil growing environment.
Provides an oxygen enriched growing environment that helps to improve root health and size, creating bigger, faster growing more resilient plants.
Helps nutrient mobilisation in plants.
Reduces levels of bad pathogens in irrigation water, which provides better water quality for plant growth.
Has been shown to stimulate gibberellic acid hormone production in plants (causing plants to increase growth rate).
Provides a chemical-free means for improving water quality.
Can lead to increased soil infiltration rate due to the reduced surface tension of nanobubble water, which can help increase water use efficiency.
Improve soil structure and reduce compaction via increased soil flocculation.

A wide range of devices can be used to generate nanobubbles. Typically, for high water flow rates, transfer efficiency significantly decreases (% of input gas mass dissolved/transferred to water) and energy/head loss (energy required to pump water through nanobubble generator) greatly increases. This means both OPEX is much higher as well as CAPEX of supporting infrastructure (i.e. need larger pumps, and consequently an upgraded electrical system to match, which adds considerable cost to overall system installation). Current devices generally suffer from poor transfer efficiency and/or poor energy efficiency at high water flows. Some nanobubble generators are also prone to blockage and difficult to maintain in contaminated water systems such as wastewater or farm effluent.

It is an object of the invention to provide an improved nanobubble generator or to at least provide the public with a useful alternative.

### SUMMARY

According to one example embodiment there is provided a nanobubble generator comprising:
a. an inlet manifold;
b. an outlet manifold;
c. a plurality of mixing tubes between the inlet manifold and outlet manifold having internal helical guides configured to produce nanobubbles in a liquid passing through the nanobubble generator; and
d. one or more gas injection ports near the inlets to the mixing tubes, wherein the mixing tubes follow a twisted path from the inlet manifold to the outlet manifold.

According to another example embodiment there is provided a nanobubble generator comprising:
i. an inlet manifold;
ii. an outlet manifold;
iii. a plurality of mixing tubes between the inlet manifold and outlet manifold; and
iv. one or more gas injection ports near the inlets to the mixing tubes, wherein the mixing tubes have internal helical guides configured to generate nanobubbles in a liquid passing through the nanobubble generator.

According to another example embodiment there is provided a nanobubble generator comprising:
a. an inlet manifold;
b. an outlet manifold;
c. a plurality of mixing tubes between the inlet manifold and outlet manifold having internal helical guides configured to produce nanobubbles in a liquid passing through the nanobubble generator; and
d. one or more gas injection ports near the inlets to the mixing tubes, wherein one or more of the mixing tubes follow a twisted path from the inlet manifold to the outlet manifold and one or more of the mixing tubes follow a straight path from the inlet manifold to the outlet manifold.

According to a further example embodiment there is provided a nanobubble generator comprising:
i. an inlet manifold;
ii. an outlet manifold;
iii. a plurality of mixing tubes between the inlet manifold and outlet manifold; and
iv. one or more gas injection ports near the inlets to the mixing tubes, wherein the mixing tubes have internal helical guides configured to produce a gas core in each mixing tube to facilitate nanobubble generation in a liquid passing through the nanobubble generator.

According to a further example embodiment there is provided a nanobubble generator comprising:
i. an inlet manifold;
ii. an outlet manifold;
iii. a plurality of mixing tubes between the inlet manifold and outlet manifold; and
iv. one or more gas injection ports near the inlets to the mixing tubes, wherein the mixing tubes have internal helical guides configured to swirl the fluid to pull the gas toward the central axis of the tube to facilitate nanobubble generation in a liquid passing through the nanobubble generator.

According to a further example embodiment there is provided a nanobubble generator comprising:
a. an inlet manifold;
b. an outlet manifold;
C. a plurality of mixing tubes between the inlet manifold and outlet manifold having internal helical guides configured to produce nanobubbles in a liquid passing through the nanobubble generator; and
d. an air inlet near the inlet to each mixing tube, wherein the cross-sectional area through the nanobubble generator remains substantially constant.

Examples may be implemented according to any one of the dependent claims at the end of this specification.

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning-i.e., they will be taken to mean an inclusion of the listed components which the use directly references, and possibly also of other non-specified components or elements.

Reference to any document in this specification does not constitute an admission that it is prior art, validly combinable with other documents or that it forms part of the common general knowledge.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention, in which:

FIG. 1 is a perspective view of a nanobubble generator according to a first example;

FIG. 2 is a plan view of the nanobubble generator of FIG. 1;

FIG. 3 is a cross-sectional plan view through plane A-A indicted in FIG. 2;

FIG. 4 is an end view from the inlet end of the nanobubble generator of FIG. 1;

FIG. 5 is an end view from the outlet end of the nanobubble generator of FIG. 1;

FIG. 6 is a perspective view of a nanobubble generator according to a second example;

FIG. 7 is a plan view of the nanobubble generator of FIG. 6;

FIG. 8 is a cross-sectional plan view of the nanobubble generator through plane A-A in FIG. 7;

FIG. 9 is an end view from the inlet end of the nanobubble generator of FIG. 6;

FIG. 10 is an end view from the outlet end of the nanobubble generator of FIG. 6;

FIG. 11 is a perspective view of a mixing tube of the nanobubble generator of FIG. 6;

FIGS. 12a to 12d are perspective cross-sectional views of different helical guides for use in the mixing tube shown in FIG. 11;

FIG. 13 is a perspective view of a nanobubble generator according to a further example;

FIG. 14 is a plan view of the nanobubble generator of FIG. 13;

FIG. 15 is a cross-sectional plan view of the nanobubble generator through plane A-A in FIG. 14;

FIG. 16 is an end view from the inlet end of the nanobubble generator of FIG. 13;

FIG. 17 is an end view from the outlet end of the nanobubble generator of FIG. 13;

FIG. 18 is a perspective view of a nanobubble generator according to a further example;

FIG. 19 is a side view of the nanobubble generator shown in FIG. 18; FIG. 20 is a cross-sectional view of the nanobubble generator through plane A-A shown in FIG. 19;

FIG. 21 shows the inlet of the nanobubble generator shown in FIG. 18; and

FIG. 22 shows the outlet of the nanobubble generator shown in FIG. 18.

### DETAILED DESCRIPTION

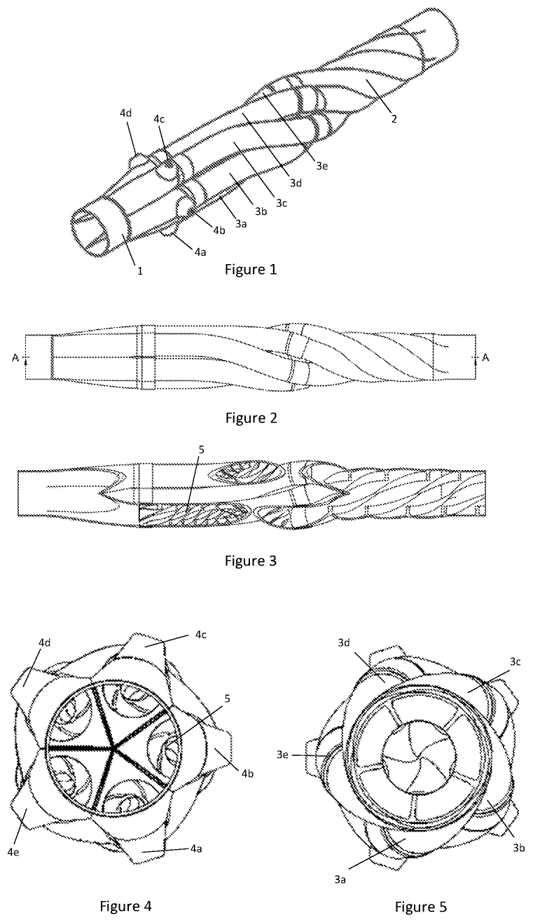

FIGS. 1 to 5 show a nanobubble generator according to a first example. The nanobubble generator includes an inlet manifold 1, an outlet manifold 2 and a plurality of twisted mixing tubes 3a to 3e between the inlet manifold 1 and outlet manifold 2. In this example the mixing tubes follow a generally helical path but other twisted forms may be employed. Gas injection ports 4a to 4e are provided near to the liquid inlet to each mixing tube, in this case they are provided on the inlet manifold 1. Whilst one gas injection port per mixing tube is shown in this example it is to be appreciated that one or more gas injection port may be provided in the inlet manifold and/or mixing tubes.

The geometry of the components results in a smooth flow path without sudden transitions. The inlet manifold 1 provides a smooth continuous transition from the inlet of the nanobubble generator through to each mixing tube and the outlet manifold 2 provides a smooth continuous transition from each mixing tube through to the outlet of the nanobubble generator.

Smooth entry and exit flow paths minimise head losses and maintain the momentum of the flow. The smooth combining of the individual flows through the mixing tubes, also maintains the rotational momentum from each individual tube through outer rotating motion of the combined fluid flow.

Each mixing tube has a static internal helical guide 5 (only one indicated) which spins the incoming fluid (which may take the form of any of the guides shown in FIGS. 12a to 12d described below). According to the applicant's best understanding the internal helical guides 5 are configured so as to produce swirl flow which achieves the following combined effects which facilitate nanobubble generation in a liquid passing through the nanobubble generator:
Produces a less dense gas core through central axis of mixing tube.
Induces shear on the two-phase flow.
Reduces local pressure through central axis of mixing tube toward vapor pressure.

The helical guides may be integrally formed with the mixing tubes (by 3D printing or other techniques) or may be inserted within the mixing tubes.

In this example the pitch of the internal helical guides 5, increases along at least part of the mixing tubes 3a to 3e, for a smoother transition into swirl flow. In this example the pitch increases at least to the mid-section of each tube. However, constant pitch internal helical guides can also provide adequate performance.

In this example, the majority of nanobubble generation occurs from the beginning of the mixing tubes 3a to 3e to the end of the outlet manifold 2. The total internal cross-sectional area preferably remains substantially the same along the length of the mixing tubes and outlet manifold to avoid flow restrictions that may decrease energy efficiency. In some cases the internal cross-sectional area variance may be ±10%, ±20%, ±30% or more. In some cases the internal cross-sectional area through the mixing tubes may be substantially the same as the internal cross-sectional area of the inlet of the inlet manifold.

It will be seen that when the mixing tubes combine in the outlet manifold 2, the diameter of fluid flow path around the central axis of the nanobubble generator decreases, creating a similar swirl flow effect seen inside each individual mixing tube by combining the separate streams from the parallel pipes at a certain pitch, which continues after the nanobubble generator to provide an increased/prolonged swirl flow effect prolonging vortex breakdown of the separate streams down the line. This increased/prolonged swirl flow effect, induced by the combination of streams at a certain pitch prolongs the shearing of the two-phase flow, allowing increased transfer of gas and formation of nanobubbles and helps preserve the rotational momentum of the separate co-rotating streams for greater stability of the extremely turbulent flow.

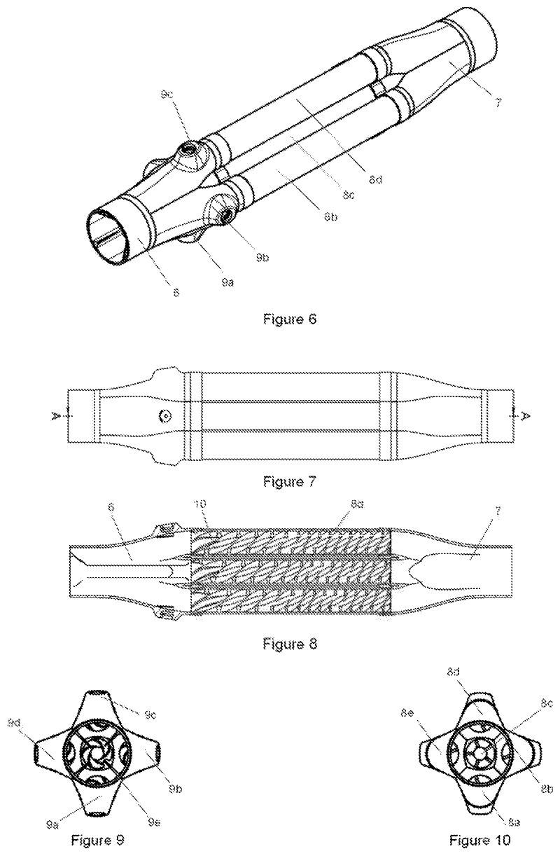

FIGS. 6 to 12 show a nanobubble generator according to a second example. The nanobubble generator is very similar to the first example except that instead of twisted mixing tubes straight mixing tubes are employed. Straight mixing tubes are simpler to manufacture and maintain but may be less efficient and so may be not as suitable in some applications.

The nanobubble generator of the second example includes an inlet manifold 6, an outlet manifold 7 and a plurality of straight mixing tube 8a to 8e between the inlet manifold 6 and outlet manifold 7. In this example the mixing tubes follow a generally straight path. Gas injection ports 9 a to 9e are provided near to the liquid inlet to each mixing tube. Whilst one gas injection port per mixing tube is shown in this example it is to be appreciated that one or more gas injection ports may be provided in the inlet manifold and/or mixing tubes.

The geometry of the components results in a smooth flow path without discontinuities. The inlet manifold 6 provides a smooth continuous transition from the inlet of the nanobubble generator through to each mixing tube and the outlet manifold 7 provides a smooth continuous transition from each mixing tube through to the outlet of the nanobubble generator. Smooth entry and exit flow paths minimise head losses and help maintain the momentum of the flow.

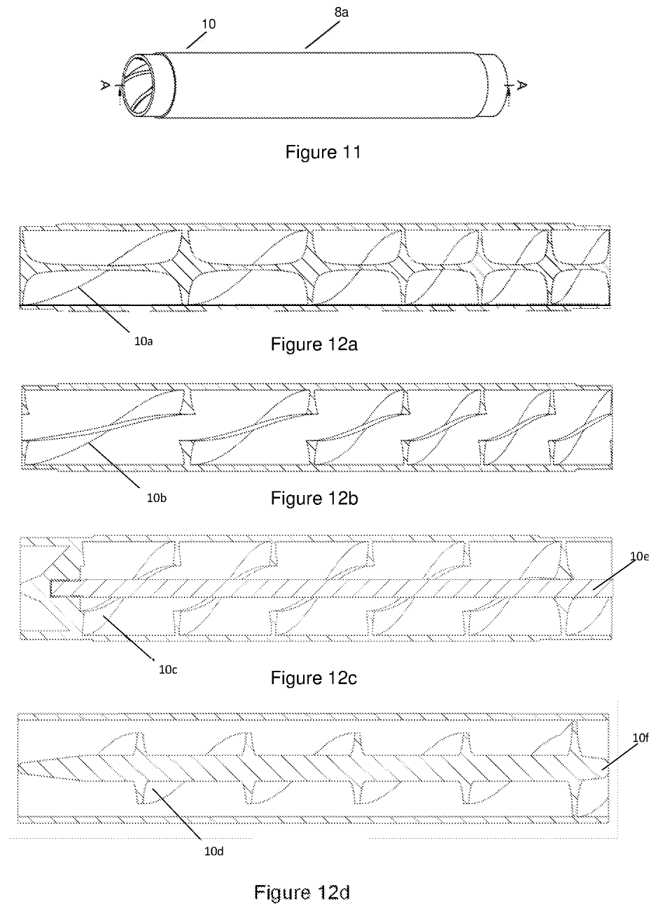

The mixing tubes have internal helical guides 10 (only one indicated). FIGS. 12a-12d show a number of possible helical guide designs that may be used in a mixing tube (tube 8a shown as an example in FIG. 11) of the nanobubble generator shown in FIGS. 6 to 10. The helical guides may be in the form of helical fins 10a extending inwardly from the internal wall of each mixing tube and connecting at the central axis of the tube as shown in FIG. 12a. Alternatively, the helical guides 10b may partially extend inwardly from the internal wall of each mixing tube to leave a hollow gap through the central axis of the tube as shown in FIG. 12b. Alternatively, the helical guides 10c may partially extend inwardly from the internal wall of each mixing tube to leave a hollow gap through the central axis of the tube around a solid core 10e with a smooth surface as shown in FIG. 12c. Alternatively, the helical guides 10d may partially extend outwardly from a smooth solid core 10f through the central axis of the tube to leave a gap around the inner wall of the mixing tube as shown in FIG. 12d.

The helical guide designs shown in FIGS. 12a to 12d condition the fluid in a similar way but have slight differences in pressure loss across the tube, nanobubble generation and gas to liquid transfer, making certain geometries attractive in certain applications. These helical guide designs may be used in any nanobubble generator described in this specification and other designs may be employed in other applications.

According to our best understanding the internal helical guides 10 are configured so as to produce swirl flow which achieves the following combined effects to facilitate nanobubble generation in a liquid passing through the nanobubble generator:
Produces a less dense gas core through central axis of mixing tube.
Induces shear on the two-phase flow.
Reduces local pressure through central axis of mixing tube toward vapor pressure.

The helical guides may be integrally formed with the mixing tubes (by 3D printing or other techniques) or may be inserted within the mixing tubes.

In this example the pitch of the internal helical guides 10 increases along at least part of the mixing tubes 8a to 8e for a smoother transition into swirl flow. However, constant pitch internal helical guides can also provide adequate performance.

In this example nanobubble generation occurs from the beginning of the mixing tubes 8a to 8e to the end of the mixing tubes 8a to 8e. The total internal cross-sectional area preferably remains substantially the same along the length of the mixing tubes and outlet manifold to avoid flow restrictions that may decrease energy efficiency. In some cases the cross-sectional area variance may be ±10%, ±20%, ±30% or more. In some cases the internal cross-sectional area through the mixing tubes may be substantially the same as the internal cross-sectional area of the inlet of the inlet manifold.

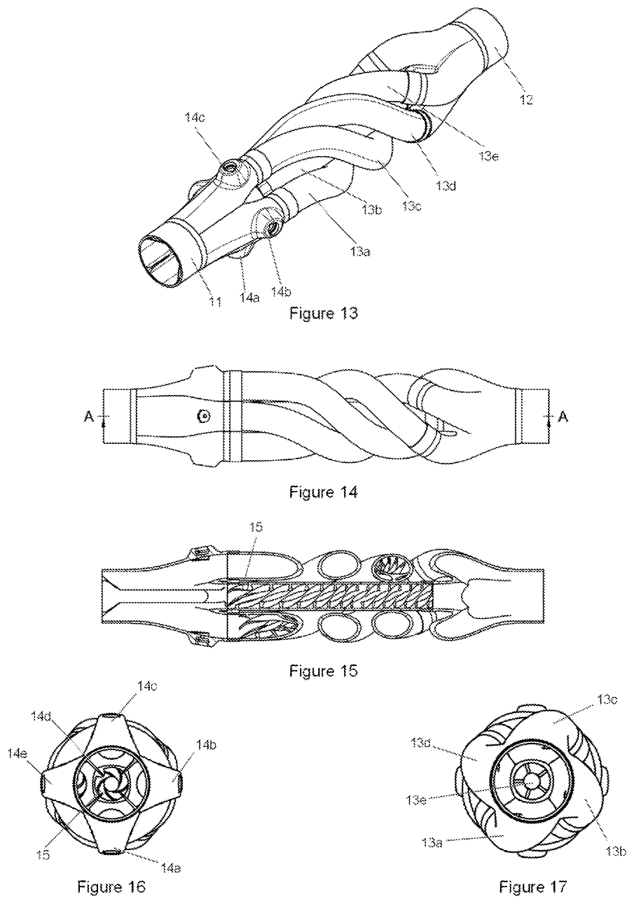

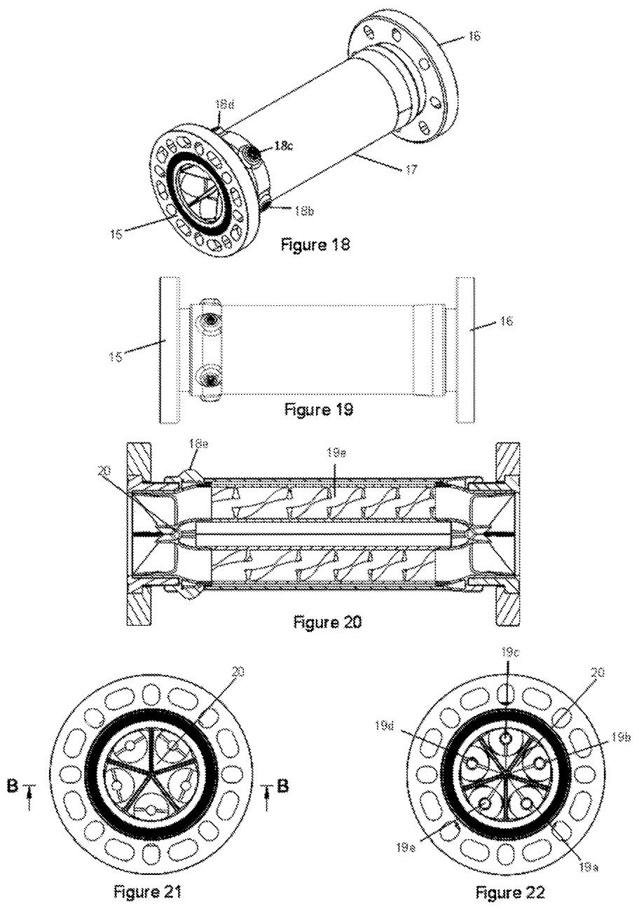

FIGS. 13 to 17 show a further example in which the nanobubble generator includes a straight central mixing tube 13e surrounded by a plurality of twisted mixing tubes 13a to 13d between inlet manifold 11 and outlet manifold 12. Gas injection ports 14a to 14e are provided near to the liquid inlet to each mixing tube. Internal helical guides 15 (only one indicated) are provided within each tube which may take the same form as in the examples described above. This example may provide a slightly more compact design where twisted mixing tubes are employed. FIGS. 18 to 22 show a further example in which the nanobubble generator includes a straight tube 17 housing an inset 20 that transitions from a circular cross-section at the inlet to define five radially spaced tubes containing helical guides 19a to 19e, that then transitions back to a circular cross-section at the outlet. The inlet 15 includes gas inlets 18a to 18e proximate the start of each helical guide 19a to 19e. The reconverged flow exits via outlet 16.

This design allows the multiple mixing tubes of the previous designs to be replaced by a single insert 20 within tube 17. Insert 20 may be formed of moulded plastics and so may be inexpensive and allow inserts to be easily selected from a set of designs to suit each application. For example, the inserts may provide straight or twisted flow paths with different numbers of flow paths. A wide range of guides may be used with each insert, such as the examples in FIGS. 12a to 12d. The design provides a compact design that is easily mated to inlet and outlet pipes and provides a smooth transition from the upstream mated pipe, through the inlet to the mixing tubes, where cross sectional area decreases through the inlet, and then maintains substantially constant through the mixing tubes before multiple streams converge and smoothly transition through the increasing cross sectional area as pipes converge at the outlet. This provides smooth transitions in and out of the device and constant cross sectional area through the mixing tubes to reduce head losses.

The nanobubble generators described above may be integrally formed having a single inlet and single outlet for connection to supply and outlet lines, making the devices easily connected into irrigation systems. The inlet manifold can be integrally formed by moulding or 3D printing etc. with an inlet providing flow paths to multiple outlets. The outlet manifold can be integrally formed by moulding or 3D printing etc. with multiple inlets converging to a common outlet. The inlet manifold, outlet manifold and mixing tubes may be formed as parts and joined into an integral unit or may be formed in one piece by 3D printing etc.

These nanobubble generators may be particularly advantageous at flow rates above 10 litres per second, with greater benefits above flow rates of 30 litres per second. The design is particularly suited to horticultural application between 20 to 150 litres per second, although it can be used for higher flow rates too and in other applications. Two, three, four or more mixing tubes may be employed depending upon the flow rate, economics and other design considerations.

In horticultural and agricultural applications, water possessing high dissolved gas concentrations and high nanobubble concentrations, as a result of mass transfer of gas to liquid through the use of nanobubbles, will typically be irrigated or applied close to the ground. Such as, but not limited to use of, dripper irrigation and low hanging sprinklers. This is to minimise gas losses to atmosphere and ensure high dissolved gas concentration in liquid gets to root zone of the crop.

In agricultural and horticultural applications, the gas supplied to create the nanobubbles will typically be oxygen (typically from an oxygen concentrator) or air. Other gasses, such as ozone, carbon dioxide, methane etc. may also be used, as well as in other applications.

There is thus provided nanobubble generators that are simple, inexpensive and easy to maintain, whilst having high transfer efficiency and lower head loss. Whilst performance will depend upon other system parameters and design choices in a typical application the described nanobubble generators can have head losses of only 2.5 psi-5 psi, compared to industry standard values of 4-12 psi. The described nanobubble generators can also typically add 20-30 mg of oxygen per litre per pass through the generator (although this again varies with system parameters and design choices). This results in lower CAPEX and OPEX of both nanobubble generator and overall system integration within existing infrastructure, as well as higher plant response or system performance in other applications, due to higher nanobubble and dissolved gas concentration, and increased return on investment. As the design has no moving parts it is less prone to failure. The design has low risk of fouling, especially compared to membrane type generators.

Using multiple mixing paths of smaller diameter provides higher gas to liquid transfer efficiency. We understand that the tangential velocity component at the outer wall, and associated total combined frictional losses, of swirl flow in a pipe is lower in multiple pipes of smaller diameter rather than a singular larger diameter pipe with similar vorticity and combined cross sectional area. When water in pipes is spinning (swirl flow), this creates a locally lower pressure toward the central axis of the pipe and lesser dense fluid moves toward the central axis of the pipe to create a less dense gas core where the water acts on the gas in a shearing nature. When multiple small pipes are provided, rather than one large pipe, several central smaller gas cores are provided rather than one large gas core, which creates a larger surface area (gas core to liquid interface) of gas to water for shearing to take place.

By maintaining a generally constant cross-sectional internal area through the device with smooth continuous transitions through the manifolds sudden obstructions to the flow may be avoided and higher energy efficiency may be achieved.

Where the mixing pipes are twisted about the central axis of the nanobubble generator and combined at a certain pitch the rotational momentum of the flow in individual pipes may be combined (individual vortexes combine to keep spinning about central axis to prolong vortex breakdown) down the pipe to reduce the destructive effect of combining co-rotating streams, resulting in even lower head loss and energy usage.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

1. A nanobubble generator comprising:
a. an inlet manifold;
b. an outlet manifold;
C. a plurality of mixing tubes between the inlet manifold and outlet manifold having internal helical guides configured to produce nanobubbles in a liquid passing through the nanobubble generator; and
d. one or more gas injection ports near the inlets to the mixing tubes, wherein the mixing tubes follow a twisted path from the inlet manifold to the outlet manifold,
wherein the total internal cross-sectional area varies by no more than 30% along the length of the mixing tubes and outlet manifold.

2. (canceled)

3. (canceled)

4. (canceled)

5. (canceled)

6. (canceled)

7. (canceled)

8. (canceled)

9. (canceled)

10. A nanobubble generator as claimed in claim 1 including three or more mixing tubes.

11. A nanobubble generator as claimed in claim 1 wherein the pitch of the internal helical guides increases along at least part of the mixing tube.

12. A nanobubble generator as claimed in claim 1 wherein the outer diameter of the rotating mixing pipes reduces towards the outlet manifold so as to induce a vortex effect in the fluid flow

13. A nanobubble generator as claimed in claim 1 wherein the internal helical guides extend inwardly from the internal wall of each mixing tube whilst leaving the central region of each mixing tube hollow.

14. A nanobubble generator as claimed in claim 1 wherein the mixing tubes follow a generally helical path from the inlet manifold to the outlet manifold.

15. A nanobubble generator as claimed in claim 1 wherein the internal helical guides are configured to produce a gas core in each mixing tube to facilitate nanobubble generation in a liquid passing through the nanobubble generator.

16. A nanobubble generator comprising:
i. an inlet manifold;
ii. an outlet manifold;
iii. a plurality of mixing tubes between the inlet manifold and outlet manifold; and
iv. one or more gas injection ports near the inlets to the mixing tubes,
wherein the mixing tubes have internal helical guides configured to produce a gas core in each mixing tube to facilitate nanobubble generation in a liquid passing through the nanobubble generator,
wherein the total internal cross-sectional area varies by no more than 30% along the length of the mixing tubes and outlet manifold.

17. A nanobubble generator as claimed in claim 16 wherein the total internal cross-sectional area remains substantially the same along the length of the mixing tubes and outlet manifold.

18. A nanobubble generator as claimed in claim 16 wherein the total internal cross-sectional area varies by no more than 10% along the length of the mixing tubes and outlet manifold.

19. A nanobubble generator as claimed in claim 16 wherein the total internal cross-sectional area varies by no more than 20% along the length of the mixing tubes and outlet manifold.

20. (canceled)

21. (canceled)

22. (canceled)

23. (canceled)

24. (canceled)

25. A nanobubble generator as claimed in claim 16 including three or more mixing tubes.

26. A nanobubble generator as claimed in claim 16 wherein the pitch of the internal helical guides increases along at least part of the mixing tube.

27. A nanobubble generator as claimed in claim 16 wherein the internal helical guides are configured to produce a gas core in each mixing tube to facilitate nanobubble generation in a liquid passing through the nanobubble generator.

28. A nanobubble generator as claimed in claim 16 wherein a gas injection port is provided near to the beginning of each mixing tube.

29. A nanobubble generator comprising:
a. an inlet manifold;
b. an outlet manifold;
c. a plurality of mixing tubes between the inlet manifold and outlet manifold having internal helical guides configured to produce nanobubbles in a liquid passing through the nanobubble generator; and
d. one or more gas injection ports near the inlets to the mixing tubes, wherein one or more of the mixing tubes follow a twisted path from the inlet manifold to the outlet manifold and one or more of the mixing tubes follow a straight path from the inlet manifold to the outlet manifold,
wherein the total internal cross-sectional area varies by no more than 30% along the length of the mixing tubes and outlet manifold.

30. (canceled)

31. (canceled)

32. (canceled)

33. A nanobubble generator as claimed in claim 16 wherein the helical guides are in the form of helical fins extending inwardly from the internal wall of each mixing tube and are connected along a central axis.

34. A nanobubble generator as claimed in claim 16 wherein the helical guides partially extend inwardly from the internal wall of each mixing tube to leave a hollow gap through a central axis of each mixing tube.

35. A nanobubble generator as claimed in claim 16 wherein the helical guides extend inwardly from the internal wall of each mixing tube to leave a hollow gap through the central axis of the tube around a solid core.

36. A nanobubble generator as claimed in claim 16 wherein the helical guides partially extend outwardly from a smooth solid core through a central axis of the tube to leave a gap between each helical guide and the inner wall of each mixing tube.

37. (canceled)

38. (canceled)

39. (canceled)

40. (canceled)

41. (canceled)

42. (canceled)

43. (canceled)
